(19) United States
(12) Patent Application Publication
(10) Pub. No.: US 2016/0352854 A1
(43) Pub. Date: Dec. 1, 2016

(54) Continually Updating a Channel of Aggregated and Curated Media Content Using Metadata

(71) Applicant: Fred Silverman, Bedford Hills, NY (US)

(72) Inventor: Fred Silverman, Bedford Hills, NY (US)

(21) Appl. No.: 15/231,903

(22) Filed: Aug. 9, 2016

Related U.S. Application Data
(63) Continuation of application No. 13/891,396, filed on May 10, 2013, now abandoned.
(60) Provisional application No. 61/645,979, filed on May 11, 2012.

(51) Int. Cl. H04L 29/08; H04L 29/06

(52) U.S. Cl. CPC H04L 67/2833; H04L 65/601; H04L 67/2804; H04L 67/02

(57) ABSTRACT

A method and system for aggregating and curating a plurality of media content pieces. The method including the steps of aggregating a plurality of media content pieces from various sources and curating each of the plurality of media content pieces to determine metadata associated with each of the plurality of media content pieces including an ideology level for each of the media content pieces. Each of the media content pieces and determined metadata are stored in a database. The stored/aggregated media content pieces are then made accessible to a user using a search feature that selects at least one of the plurality of media content pieces based upon metadata stored in the database. A user also can define a channel of media using metadata. The system selects, and continually updates, a list of media content pieces matching the metadata.

### CROSS-REFERENCE TO RELATED APPLICATIONS

This application is a continuation of U.S. patent application Ser. No. 13/891,396, entitiled “Continually Updating a Channel of Aggregated and Curated Media Content Using Metadata”, and filed May 10, 2013, pending, which is a non-provisional application of provisional patent application 61/645,979, entitled “System and method for aggregating and curating content”, filed May 11, 2012, expired, both of which are hereby incorporated by reference.

### FIELD OF THE INVENTION

The invention relates to a system and method for aggregating media content, and more specifically, for certain aggregated media content.

### BACKGROUND OF THE INVENTION

Today's broadcast corporations, advertising agencies, consumer products and services companies, and other businesses have demanding media asset management needs. These organizations have been simultaneously empowered by the growth in tools and infrastructure for creating, storing and transporting media-rich files and challenged by the problem of managing the media assets that they've amassed and come to rely upon for their core businesses. The sheer volume of information available over the World Wide Web and corporate networks continues to accelerate. Because media assets are so crucial to these companies, they have an extreme need for an intelligent and efficient way to catalog, browse, search and manage their media assets. Prior attempts at content management solutions have yielded point solutions or proprietary applications. These applications have not leveraged the technologies already deployed by many organizations, such as industry-standard browsers and Web servers.

As the World Wde Web has emerged as a major research tool across all fields of study, the concept of metadata has become a crucial topic. Metadata, which can be broadly defined as “data about data,” refers to the searchable definitions used to locate information. This issue is particularly relevant to searches on the Web, where metatags may determine the ease with which a particular Web site is located by searchers. Metadata that are embedded with content is called embedded metadata. A data repository typically stores the metadata detached from the data.

Results obtained from search engine queries are limited to metadata information stored in a data repository, referred to as an index. With respect to media files or streams, the metadata information that describes the audio content or the video content is typically limited to information provided by the content publisher. For example, the metadata information associated with audio/video podcasts generally consists of a URL link to the podcast, title, and a brief summary of its content. If this limited information fails to satisfy a search query, the search engine is not likely to provide the corresponding audio/video podcast as a search result even if the actual content of the audio/video podcast satisfies the query.

### SUMMARY OF THE INVENTION

A plurality of media content pieces are aggregated and cu rate d from various sources to determine metadata associated with each of the plurality of media content pieces. The metadata preferably includes a determined ideology level for each of the media content pieces. Each of the media content pieces and determined metadata are stored in a database. The stored/aggregated media content pieces are then made accessible to a user using a search feature that selects at least one of the plurality of media content pieces based upon metadata stored in the database.

The system also provides an interface through which the user can specify metadata, to define a channel of media in which the user is interested. The system selects at least one of the plurality of media content pieces from the storage based upon the user specified metadata and the metadata stored in the storage. The selected media content pieces are continually updated according to the user-specified metadata as content is added to the system. The system in turn provides an indication of the selected media content pieces, as continually updated, to the user. When implemented as a self-contained widget, such as an application on a personal or tablet computer, the user is provided with a custom channel of continually update media matching the user-specified metadata.

In further, optional aspects, the foregoing method can include the additional step of selectively relating each of the plurality of media content pieces based upon the stored metadata relating to each of the plurality of media content pieces. In another aspect of the invention, a filter is provided for enabling a user to select an ideology level of media content pieces desired to be retrieved by the user.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 is a block diagram of a computer system to be used with illustrated embodiments of the invention;

FIG. 2 is a system level diagram depicting an environment of use for the invention is accordance with an illustrated embodiment;

FIG. 3 is a flow chart depicting certain steps for curating media content pieces in accordance with an illustrated embodiment of the invention; and

FIGS. 4-6 depict a website for presenting curated media content pieces to a user in accordance with an illustrated embodiment of the invention.

### WRITTEN DESCRIPTION OF CERTAIN EMBODIMENTS OF THE INVENTION

The present invention is now described more fully with reference to the accompanying drawings, in which an illustrated embodiment of the invention is shown. The invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

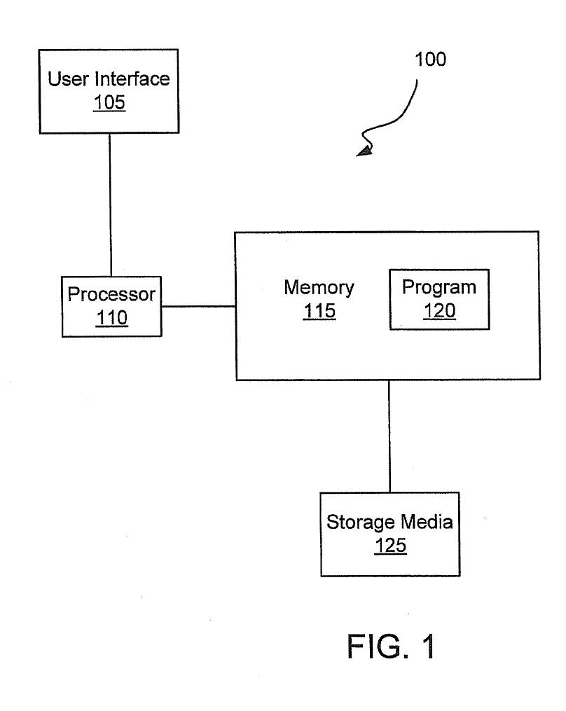

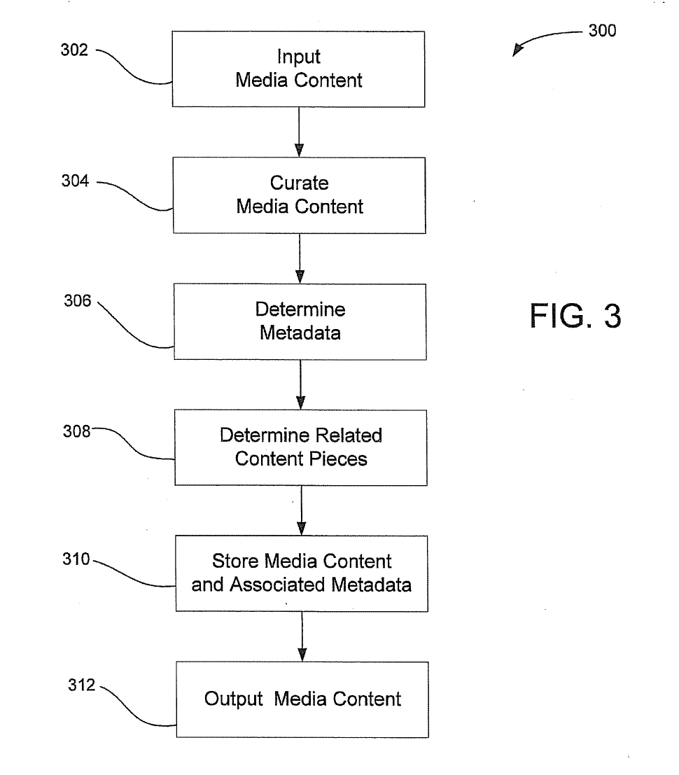

It is to be appreciated that the embodiments of this invention as discussed below may be incorporated as a software algorithm, program or code residing on computer useable medium having control logic for enabling execution on a computer system having a computer processor. The computer system typically includes memory storage configured to provide output from execution of the computer algorithm or program. Such a computer system is shown as a block diagram in FIG. 1 illustrating a computer system 100 configured for employment of method 300 (FIG. 3) in accordance with an illustrated embodiment of the invention. System 100 preferably includes a user interface 105, a processor 110, and a memory 115. System 100 may be implemented on a general purpose microcomputer, such as one of the members of the Sun® Microsystems family of computer systems, one of the members of the IBM® Personal Computer family, one of the members of the Apple® Computer family, or a myriad of other conventional workstations, desktop computer, laptop computer, a netbook computer, a personal digital assistant, or a smart phone or other like handheld devices. Although system 100 is represented herein as a standalone system, it is not limited to such, but instead can be coupled to other computer systems via a network (not shown).

Memory 115 is a memory for storing data and instructions suitable for controlling the operation of processor 110. An implementation of memory 115 would include a random access memory (RAM), a hard drive and a read only memory (ROM). One of the components stored in memory 115 is a program 120.

Program 120 includes instructions for controlling processor 110 to execute method 300. Program 120 may be implemented as a single module or as a plurality of modules that operate in cooperation with one another. Program 120 is contemplated as representing a software embodiment of the method described hereinabove.

User interface 105 preferably includes an input device, such as a keyboard, touch screen, tablet, or speech recognition subsystem, for enabling a user to communicate information and command selections to processor 110. User interface 105 also includes an output device such as a display or a printer. In the case of a touch screen, the input and output functions are provided by the same structure. A cursor control such as a mouse, track-ball, or joy stick, allows the user to manipulate a cursor on the display for communicating additional information and command selections to processor 110.

While program 120 is indicated as already loaded into memory 115, it may be configured on a storage media 125 for subsequent loading into memory 115. Storage media 125 can be any conventional storage media such as a magnetic tape, an optical storage media, a compact disc, or a floppy disc. Alternatively, storage media 125 can be a random access memory, or other type of electronic storage, located on a remote storage system.

The methods described herein have been indicated in connection with flow diagrams that facilitate a description of the principal processes; however, certain blocks can be invoked in an arbitrary order, such as when the events drive the program flow such as in an object-oriented program. Accordingly, the flow diagram is to be understood as an example flow and that the blocks can be invoked in a different order than as illustrated.

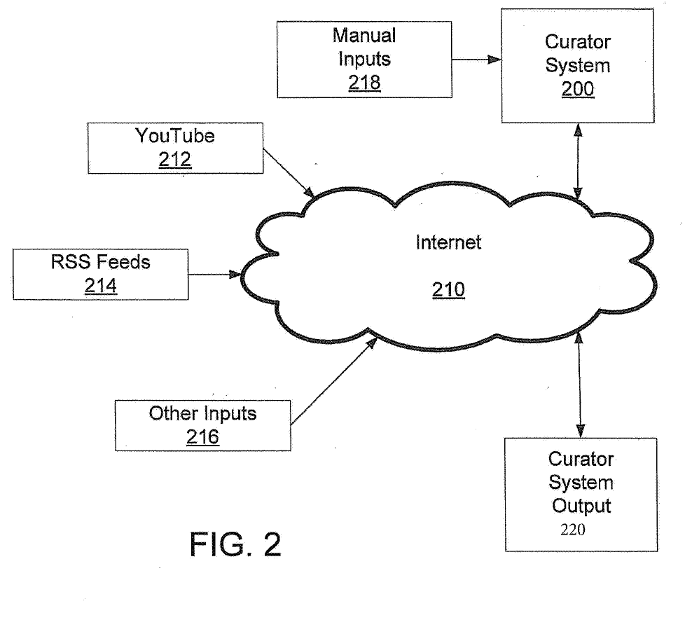

Wth reference now to FIG. 2, depicted is an illustrated environment of use for curator system 200 (preferably embodying components of the aforesaid computer system 100 of FIG. 1) in accordance with an illustrated embodiment of the present invention. As to be discussed further below, curator system 200 provides curator services preferably for inputted news and media content (“content pieces”), such as providing detailed metadata information for each input content piece to be used by a recipient for selectively choosing which content piece the recipient desires to access. It is to be appreciated that while curator system 200 is to be described in conjunction with video clip segments and news articles, it is not to be understood to be limited thereto as it may encompass various forms of content (advertisements, product reviews, literature, dramatic works, etc.) and/or data where such curator services provide a value to a recipient for selecting such content to access.

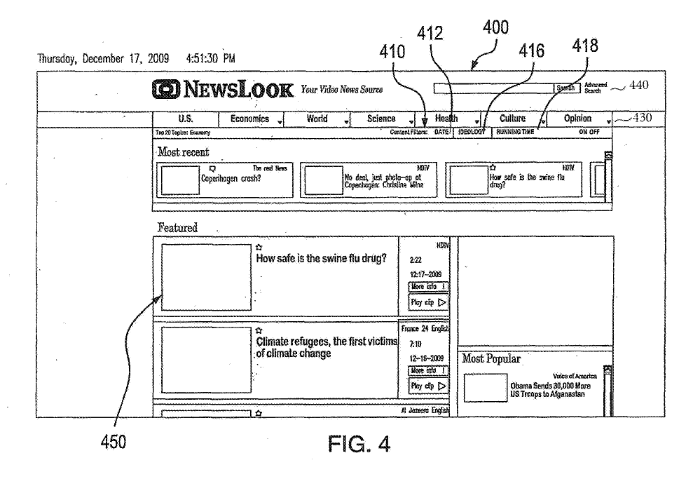

As shown in FIG. 2, content may be provided to the curator system 200 from various sources and distribution channels including YOUTUBE™ 212, RSS Feeds 214 and other like sources 216 providing desired content preferably accessible via the internet 210. Content may also be inputted directly to curator system 200 through conventional means such as pasting and cutting. As described further below, the output 220 of curator system 200 in accordance with the illustrated embodiment is provided via a website that preferably aggregates and selectively relates a plurality of content pieces. However, the output 220 of curator system 200 is not to be understood to be limited to such a website service offering as depicted in FIG. 4 but may be provided in various output formats and/or to various device types including mobile devices (such as cell phones, smart phones, PDA's and the like), cable and satellite television systems and formats, and other internet based services and formats.

Wth an environment of use described above for curator system 200, its method of operation in accordance with an illustrated embodiment will now be discussed with reference to FIG. 3. Starting at step 302, a content piece (such as a media clip) is input to curator system 200. A curation process is then performed on the aforesaid content piece to determine certain metadata associated with the content piece, step 304. It is to be appreciated this curation process may be performed on the content piece either via a software program, a manual process or a combination of both. Thus, the curation process involves determining metadata relating to certain categories of information from analysis of the content piece, step 306.

The determined curated information (metadata) (step 306) obtained from an actual review/analysis of the content piece relates to a number of categories, including (but not limited to):
Topical category (and subcategories) of the content piece (e.g., U.S., Economics (Business, Markets, Policy, Personal Finance), World (Africa, Americas, Asia/Pacific, Europe, Middle East), Science (Research, Technology, Environment), Health (Research, Aliments & Cures, Policy), Culture (Arts & Culture, Comedy) and Opinion (video blogs))
Content Piece description and/or summary
Length/Duration of the content piece (e.g., number of words, length of video/media segment)
Date of origin of the content piece
Ideology level of the content piece (preferably categorized according to a scale or spectrum ranging from very progressive to very conservative)
Supplier of content piece
Geographic location of content piece supplier

Next, at step 308, a determination is made as to what other content pieces stored in curator system 200 (which have each preferably underwent the aforesaid curation process of FIG. 3) relate to the content piece that is currently the subject of the curation process of FIG. 3. This determination is preferably based upon consideration and matching of the curated information (metadata) associated with each aforesaid stored content pieces and the content piece that is currently the subject of the curation process. This determination preferably includes factors such as (but is not limited to):
Supplier of content piece
Supplier Organization type
Supplier geographic location
Content piece description and/or summary
Content piece production date
Ideology level of content piece

After the determination of related content pieces is performed (step 308), the content piece, associated determined curated information (metadata) and preferably links to related content pieces are stored in a database/memory in curator system 200, step 310. From the aforesaid database/memory of curator system 200, the content pieces are provided to users via an output system, step 312.

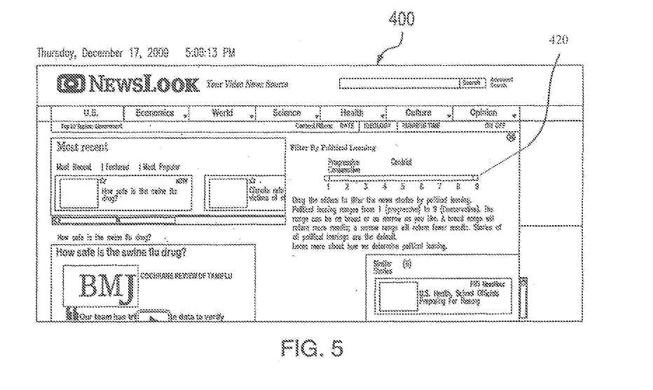

With reference now to FIG. 4, and in accordance with an illustrated embodiment of the invention, shown is a website 400 providing selective access to the content pieces stored in the curator system 200 as described above, a content filter 410 is provided which filters content pieces to be retrieved in accordance with the filter settings chosen by a user. For instance, a user can restrict retrieved content pieces according to the following determined curated information (metadata):
Date (412) of the content piece origin (e.g., today, this week, this month, this year, all dates)
Ideology (416) level of the content piece (see FIG. 5) in which preferably a sliding scale 420 is provided enabling the user to drag a slider to filter content pieces by determined ideology level for each stored content piece. As indicated in FIG. 5 the filter provides a political ideology range leaning from first setting (1) (Progressive) to a last setting (9) (Conservative). The range can be as broad or as narrow as selected by a user. Preferably, a broad range will return more results (i.e., content pieces) with a narrow range returning fewer results (i.e., content pieces)
Duration of content piece (Running time 418) (e.g., less than 3 minutes, 3-10 minutes, longer than 6 minutes)

Once the content filter settings (410) are selected by a user, all content pieces retrieved by the website portal 400 will be retrieved and filtered in accordance with the user selected filter settings. For example, if a user prescribes the filter settings (410) such that only content pieces originating from this week, are conservative rating determined, and have a duration of less than 3 minutes, then only content pieces matching this criteria will be presented to a user if the user selects the category menu (430) or search feature (440) to retrieve content pieces.

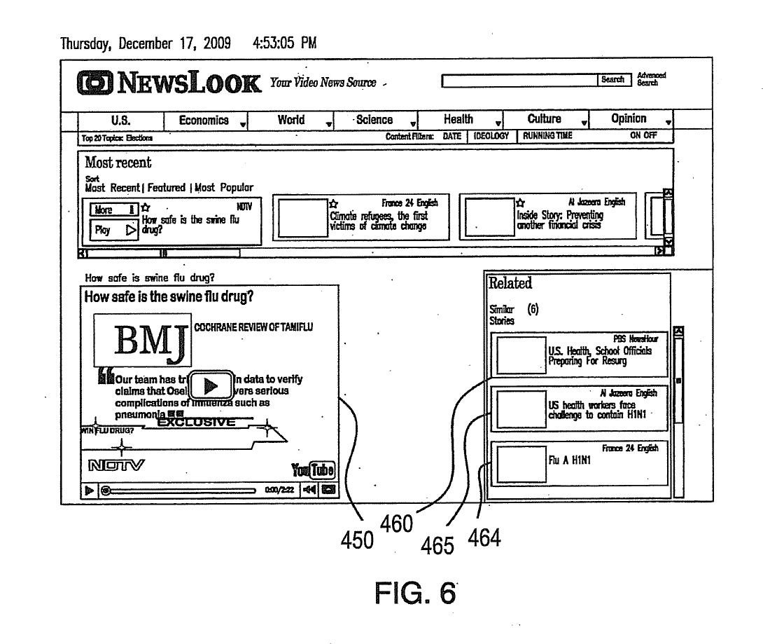

Wth reference now to FIG. 6, once a content piece (450) is presented for viewing to a user, associated with that content piece (450) are content pieces (460, 465, 464) determined to be related to the selected and presented content piece (450) in accordance with the process described above (FIG. 3, step 308).

It is to be understood other embodiments of the invention may include one or more of the following:

Ingest Feature

System 200 may include an “ingest feature”, whereby system 200 is adapted and configured to receive content and metadata from various data sources, preferably at an interval, and is functional to pair and output them jointly preferably in a standardized format to an eternal system. For instance, a source may be a RSS feed, an FTP site, an S3 bucket, or a local folder (e.g., FTP upload). It is to be appreciated a particular feature of this ingest feature is that metadata and content are reconciled at a file system level enabling metadata and content to have origins from different sources.

Export Feature

System 200 may include an “export feature” enabling system 200 to retrieve RSS feeds and retrieve and cache content locally contingent upon each feed's specifications. System 200 then preferably exports the data in a new format to an external system. It is to be appreciated a unique features include the ability to perform local caching (e.g., files that are in more than one feed are only retrieved once) and the customizable output format (e.g., the output format can be customized for each external system that receives the output).

Semantic Parsing Feature

System 200 may include a “semantic parsing feature” whereby system 200 is adapted and configured to “read” (e.g., OCR) a text document and automatically match its corresponding metadata to the metadata contained in a video file. The result is placement of video files that have matching metadata to the text document and a placement within the text.

Semantic Widget Feature

The semantic widget feature is similar to above described semantic parsing feature with an exception being the semantic widget feature utilizes a dynamic widget that continuously uploads appropriate content into a self-contained widget that matches the metadata.

More particularly, the system provides an interface, similar to the search interface, through which the user can specify metadata, to define a channel of media in which the user is interested. The system selects at least one of the plurality of media content pieces from the storage based upon the user specified metadata and the metadata stored in the storage. The selected media content pieces are continually updated according to the user-specified metadata as content is added to the system. The system in turn provides an indication of the selected media content pieces, as continually updated, to the user. When implemented as a self-contained widget, such as an application on a personal or tablet computer, the user is provided with a custom channel of continually update media matching the user-specified metadata.

In one implementation, for each user the system maintains a list of channels, each channel being specified by one or more metadata terms. Such channels are output channels for the user to view media content pieces that have been received and processed by the system from the plurality of distribution channels that provide media content pieces to the system. The channel includes a list of media content pieces having metadata that matches the metadata for the channel. When new media is added to the system, its metadata is matched against the metadata for each of the channels specified for each user. If the metadata for a media content piece matches the metadata for a channel for a user, then the media content piece is added to the list of media contents pieces for that channel for that user. When the user accesses that channel, the list of media content pieces for that channel is updated to reflect the latest added media content pieces.

When a piece of media content is added to a channel, the system also can identify related content that has similar metadata, such as described above. Such related content can be added to the channel or can be made visible to the user when the user accesses the piece of content from the channel.

With such a system, media content is received from a plurality of distribution channels as the media content is published. Examples of such distribution channels include, but are not limited to, an RSS or other type of web feed. Each user can select metadata, as well as filter settings as described above, to select and filter media content that has been aggregated from these multiple distribution channels. In turn, the user receives their own personalized channels based on their specified metadata that are continually updated as media content is published and distributed through the multiple feeds received by the system. The selected media content, and optionally related media content, for a channel for a user then can be optionally filtered and then displayed to the user. Typically such display includes a list of media content pieces for the channel in order of time of distribution from the distribution channels from which they were received.

Therefore, in accordance with the above illustrated embodiments of the invention, what has been described is a system and method that provides customized and individual curation services for each media content piece to be aggregated with one another while providing enhanced informational background material on each content piece for placing each piece in better informational perspective for a user. This system and method enables users to readily select desired media content pieces to access in accordance with each user's predetermined criteria for doing so.

Optional embodiments of the invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the scope of the present invention.

What is claimed is:

1. A computer-implemented method for aggregating a plurality of media content pieces from a plurality of distribution channels, and distributing the aggregated media content pieces to a plurality of users, the method comprising:
receiving a plurality of media content pieces from a plurality of distribution channels accessible over a computer network, wherein the media content pieces are received as the media content pieces are published by the distribution channels;
determining, using a computer processor, metadata for each of the received plurality of media content pieces;
storing the received plurality of media content pieces in storage;
storing the determined metadata in storage;
making the plurality of media content pieces stored in the storage accessible to the plurality of users over a computer network by, for each user:
providing an interface through which the user can specify metadata for a channel;
selecting, for a channel, at least one of the plurality of media content pieces from the storage based upon the user specified metadata for the channel and the metadata stored in the storage;
continually updating the selected media content pieces for the channel according to the user-specified metadata, as the media content pieces are received and stored from the distribution channels, using the determined and stored metadata for the received and stored media content pieces; and
providing an indication of the selected media content pieces for the channel, as continually updated, to the user.

2. A computer-implemented method as recited in claim 1 wherein the media content pieces are video segments.

3. A computer-implemented method as recited in claim 1 wherein the media content pieces are selected from the group consisting of video segments and written segments.

4. A computer-implemented method as recited in claim 1 wherein the metadata relates to a determined ideology level of a media content piece.

5. A computer-implemented method as recited in claim 1 wherein the provided interface comprises a website on the internet.

6. A computer-implemented method as recited in claim 5 wherein the website provides a user selectable filter for selecting metadata for media content pieces to be selected for a user.

7. A computer-implemented method as recited in claim 1, further comprising:
identifying, using a computer processor, received media content pieces that are related to one another using the metadata determined for each received media content piece.
